(19) United States
(12) Patent Application Publication
(10) Pub. No.: US 2020/0338694 A1
(43) Pub. Date: Oct. 29, 2020

(54) FOSC FIXTURING STRAP

(71) Applicant: Westek Electronics, Inc., Watsonville, CA (US)

(72) Inventor: Kevin B. LARKIN, Pebble Beach, CA (US)

(21) Appl. No.: 16/856,906

(22) Filed: Apr. 23, 2020

Related U.S. Application Data
(60) Provisional application No. 62/839,332, filed on Apr. 26, 2019.

(51) Int. Cl. B25B 5/16; B25B 5/10; B25B 5/12

(52) U.S. Cl. CPC B25B 5/16; B25B 5/12; B25B 5/104

(57) ABSTRACT

A portable workstation platform is disclosed. The portable workstation platform includes a base and an accessory mount secured to a first surface of the base. An accessory locking fixture is coupled to the accessory mount. A pair of clamp fastening tabs is secured to the first surface of the base. Further, a multi-functional clamping device that includes the portable workstation platform is disclosed. The multi-functional clamping device includes a handle portion comprising a vice grip handle and a clamping portion coupled to the handle portion. The clamping portion includes opposing clamps, wherein the base of the portable workstation platform is one of the clamps and the pair of clamp fastening tabs on the base is configured to receive the clamping portion. A second accessory mount may be coupled to the clamping portion of the multi-functional clamping device.

### CROSS-REFERENCE TO RELATED APPLICATIONS

This application claims the benefit of and claims priority of co-pending U.S. provisional patent application Ser. No. 62/839,332, filed on Apr. 26, 2019, entitled “FOSC FIXTURING STRAP” by Kevin B. Larkin, assigned to the assignee of the present application, having Attorney Docket No. WSTK-008.PRO3, and is hereby incorporated by reference in its entirety herein.

### BACKGROUND ART

It is often necessary to secure an item or work piece in a particular position. This need extends across a virtually infinite number of circumstances and environments and pertains to numerous professionals, hobbyists, and countless others working with items that need to be securely retained. Various holding devices such as C-clamps, vices, and the like, have been in use for centuries. Unfortunately, conventional holding devices are not always well suited for certain applications.

### BRIEF DESCRIPTION OF THE DRAWINGS

The accompanying drawings, which are incorporated in and form a part of this specification, illustrate embodiments of the present technology and, together with the description, serve to explain the principles of the present technology. The drawings referred to in this description should not be understood as being drawn to scale except if specifically noted.

FIG. 1A shows a side view of one embodiment of a multi-functional clamping device in accordance with the present claimed invention.

FIG. 1B shows a side view of another embodiment of a multi-functional clamping device in accordance with the present claimed invention.

FIG. 2A shows a side view of one embodiment of a multi-functional clamping device in accordance with the present claimed invention in which an accessory is coupled to the accessory mount.

FIG. 2B shows a side view of another embodiment of a multi-functional clamping device in accordance with the present claimed invention in which an accessory is coupled to the accessory mount.

FIG. 3 shows a perspective view of two multi-functional clamping devices in accordance with the present embodiments, in which each of the multi-functional clamping devices is clamped to a table and in which each multi-functional clamping device has an accessory coupled to its accessory mount.

FIG. 4 shows a perspective view of a multi-functional clamping device in accordance with the present embodiments, in which the multi-functional clamping device is clamped to a table and in which the multi-functional clamping device has an accessory coupled to its accessory mount.

FIGS. 5A-5C show side views of embodiments of a multi-functional clamping device in accordance with the present claimed invention in which the position of the handle portion is shown is various positions with respect to the clamping portion.

FIGS. 6A-6C show side views of embodiments of a multi-functional clamping device in accordance with the present claimed invention in which the position of the handle portion is shown is various positions with respect to the clamping portion.

FIGS. 7A-7B are schematic representations of top views of one embodiment of a multi-functional clamping device in accordance with the present claimed invention in which the handle portion is foldable.

FIG. 8 is a close up perspective view of two opposing clamps of the clamping portion in accordance with the present embodiments.

FIGS. 9A-9B show perspective views of opposing clamps having a non-flat clamping surface in accordance with the present embodiments.

FIGS. 10A-10D show perspective views of an embodiment of a multi-functional clamping device in accordance with the present claimed invention in which the position of the accessory mount is adjustable with respect to the clamping portion.

FIG. 11 shows a perspective view of an embodiment of a multi-functional clamping device in accordance with the present claimed invention including a support fixture coupled to the clamping portion.

FIG. 12A shows a perspective view of an embodiment of a multi-functional clamping device with a work surface in accordance with the present claimed invention.

FIGS. 12B-12C shows a perspective view of an embodiment of a multi-functional clamping device with a light in accordance with the present claimed invention.

FIGS. 12D-12E shows a perspective view of an embodiment of a multi-functional device with a strap in accordance with the present claimed invention.

FIG. 13A shows a perspective view of a portable workstation platform in accordance with the present claimed invention.

FIG. 13B shows a perspective view of the portable workstation platform, with mounting hardware in accordance with the present claimed invention.

FIG. 14A shows a perspective view of the portable workstation platform, attached to a workbench surface by a C-clamp in accordance with the present claimed invention.

FIG. 14B shows a perspective view of the portable workstation platform attached to a multi-functional clamping device in accordance with the present claimed invention.

FIG. 15 shows a perspective view of the portable workstation platform configured to accommodate a separate vise in accordance with the present claimed invention.

FIG. 16 shows a side view, similar to FIG. 2B, of a combination of the portable workstation platform attached to the multi-functional clamping device, wherein both the portable workstation platform and the multi-functional clamping device include an accessory mount.

FIGS. 17A-B shows a side view and a perspective view of a combination of the portable workstation platform attached to the multi-functional clamping device, wherein the portable workstation platform is configured to a universal mounting joint. Universal mounting joint enables 360-degree horizontal rotation and 180-degree vertical rotation for attached components.

FIGS. 18A-B shows a side view and a perspective view of a combination of the portable workstation platform attached to the multi-functional clamping device, wherein the portable workstation platform is configured to a universal mounting joint and the universal mounting joint configured to a vise. Universal mounting joint enables 360-degree horizontal rotation and 180-degree vertical rotation for attached components.

FIGS. 19A-B shows a side view and a perspective view of the portable workstation platform configured to a universal mounting joint and the universal mounting joint configured to a vise. Universal mounting joint enables 360-degree horizontal rotation and 180-degree vertical rotation for attached components.

FIG. 20 shows a support band perspective view in accordance with the present claimed invention.

FIGS. 21A-B shows a support band side view and a support band close view in accordance with the present claimed invention.

FIG. 22 shows a support band with FOSC and Vise perspective view in accordance with the present claimed invention.

FIG. 23 shows a mounted in FOSC fixturing band with FOSC dome cover in place in accordance with the present claimed invention.

FIG. 24 shows FOSC mounted in FOSC band with FOSC dome cover removed in accordance with the present claimed invention.

FIG. 25 shows an exploded perspective view and top view of a support strap assembly in accordance with the present claimed invention.

FIGS. 26A-26B shows a support strap with clamp base perspective view and FOSC support strap perspective view in accordance with the present claimed invention.

FIGS. 27A-27B shows FOSC support strap open front view and FOSC support strap closed front view in accordance with the present claimed invention.

FIG. 28 shows FOSC support strap with clamp base and FOSC perspective view in accordance with the present claimed invention.

FIG. 29 shows FOSC mounted in FOSC strap with clamp base and FOSC dome cover in place in accordance with the present claimed invention.

FIG. 30 shows FOSC mounted in FOSC strap with clamp base and FOSC dome cover removed in accordance with the present claimed invention.

FIG. 31 shows FOSC support strap with suction cup base in accordance with the present claimed invention.

FIGS. 32A-32B shows FOSC strap with table top mount base and FOSC support strap with table top mount magnetic base in accordance with the present claimed invention.

### DESCRIPTION OF EMBODIMENTS

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

### Overview

Embodiments in accordance with the present invention describe a portable workstation platform having a base. The portable workstation platform further includes an accessory mount secured to a first surface of the base, with an accessory locking fixture coupled to the accessory mount. The portable workstation platform further includes a pair of clamp fastening tabs secured to the first surface of the base.

Embodiments in accordance with the present invention further describe a combination of the portable workstation platform with a multi-functional clamping device (also referred to herein as a universal clamping system) in which a vice grip handle portion is used to control the clamping pressure exerted by a clamping portion which is comprised of a pair of opposing clamps. The base of the portable workstation platform comprises one of the clamps of the multi-functional clamping device.

Additional embodiments in accordance with the present invention further describe the combination of the portable workstation platform with the multi-functional clamping device in which the portable workstation platform and the multi-functional clamping device each include an accessory mount, one coupled to the first surface of the base and the other coupled to the clamping portion of the multi-functional clamping device.

The accessory mount(s) is(are) configured to receive and retain any of numerous accessories in a desired location and orientation. Such accessories may include, but are not limited to, vices or other holding tools, lighting fixtures, cable splicing tools, etc. Due to the variety of accessories which can be retained by the accessory mount, embodiments of the present invention are referred to as a “multi-functional” or “universal” clamping device or system. As will be described in detail below, the present workstation platform is portable, can be clamped or secured to any number of surfaces, and further allows an accessory to be moved to and retained in a virtually infinite number of positions.

### DETAILED DESCRIPTION

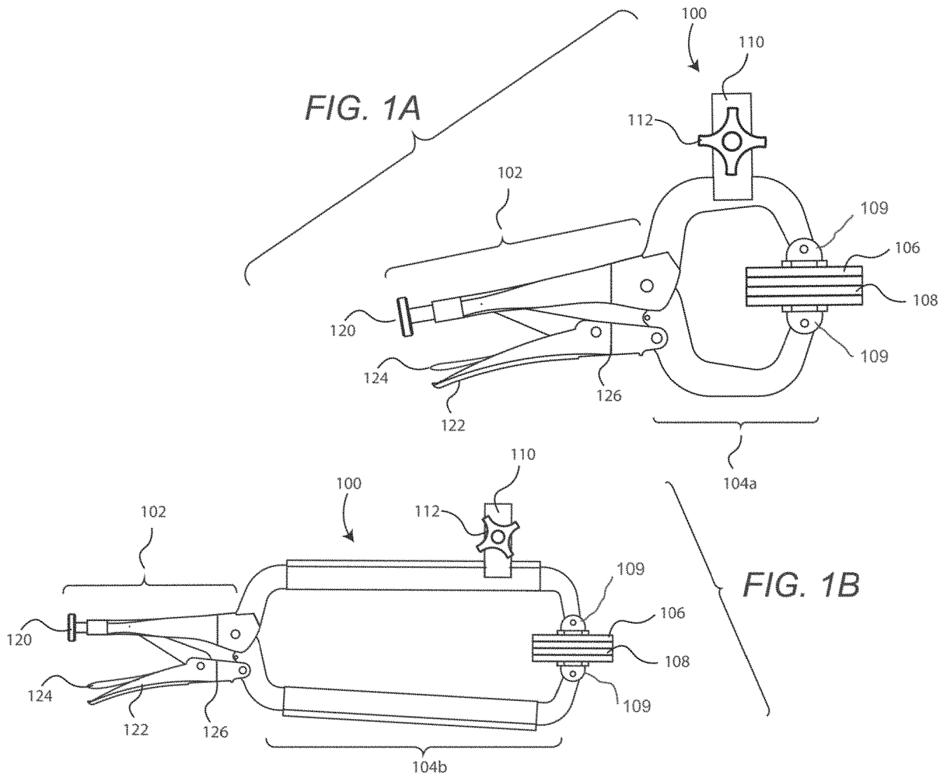

Referring now to FIG. 1A, a side view of one embodiment of a multi-functional clamping device 100 in accordance with the present claimed invention is shown. Multi-functional clamping device 100 (also referred to herein as a universal clamping system) has a vice grip handle portion 102 which is coupled to a clamping portion 104a. Clamping portions 104 further includes opposing clamps 106 and 108. The opposing clamps 106 and 108 are coupled to the clamping portions 104 by clamp fastening tabs 109.

FIG. 1B shows a side view of another embodiment of multi-functional clamping device 100 in accordance with the present claimed invention. In the embodiment of FIG. 1B, clamping portion 104b spans a greater length than clamping portion 104a of FIG. 1A. It should be understood that embodiments of the present invention are well suited to having various sizes for handle portion 102, and for clamping portions 104a and 104b. Additionally, embodiments of the present invention are also well suited to various combinations for the respective sizes of handle portion 102 and clamping portions 104a and 104b.

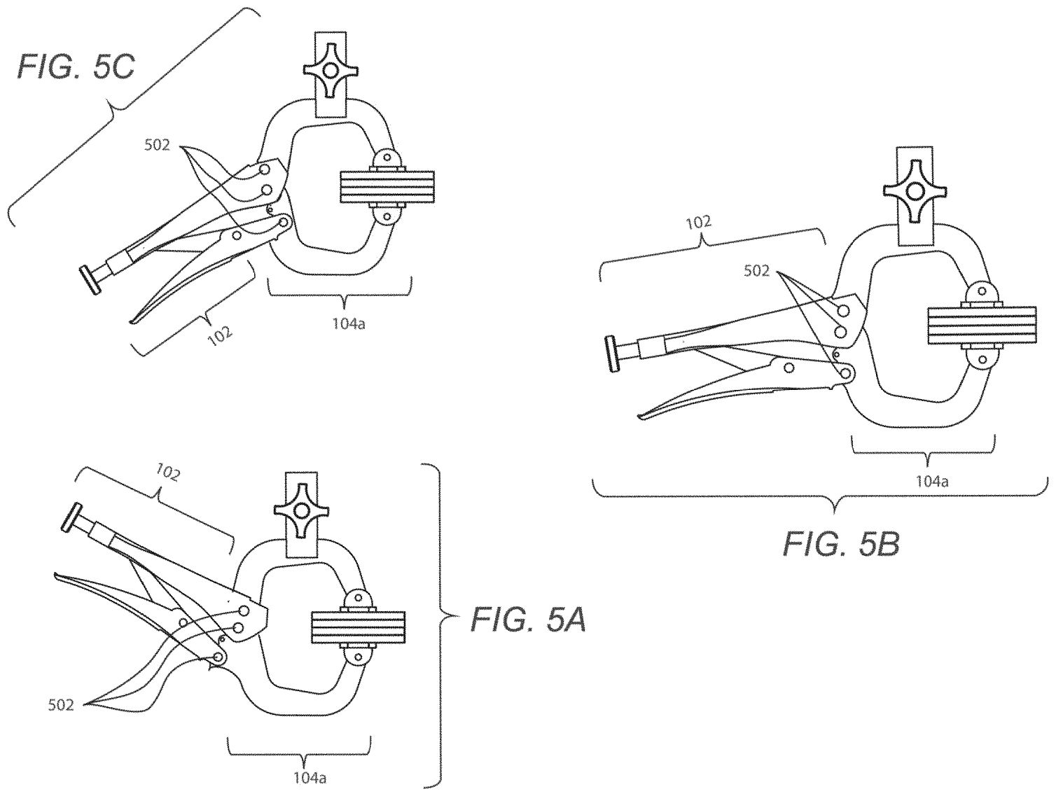

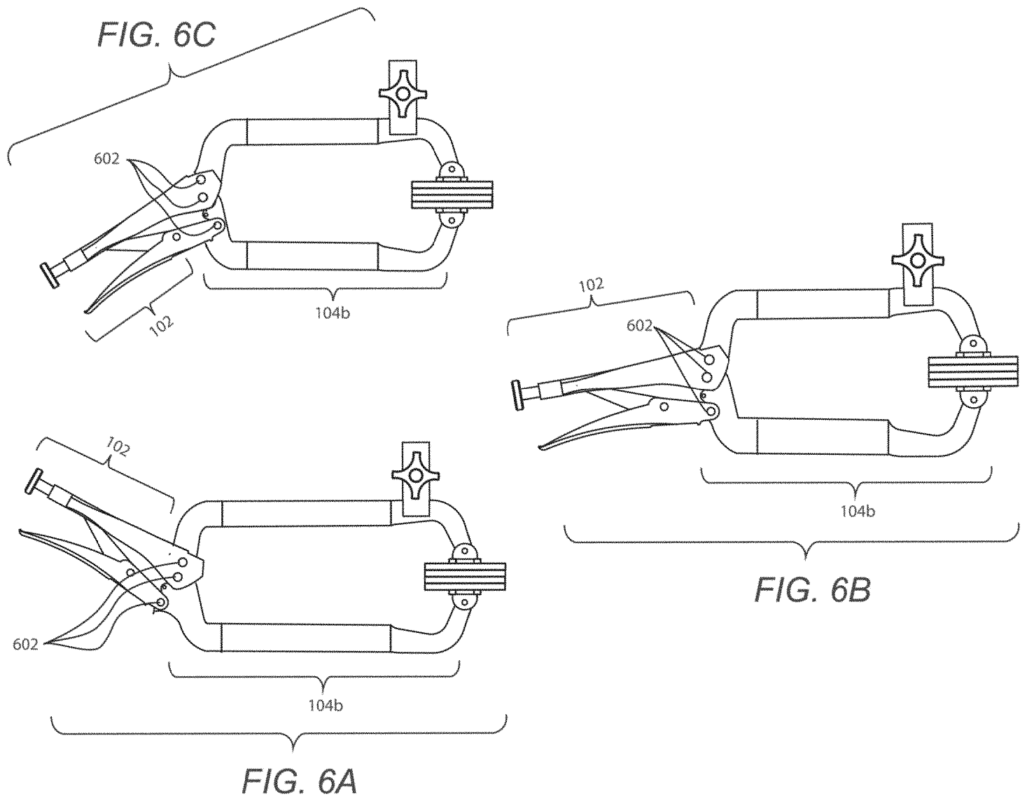

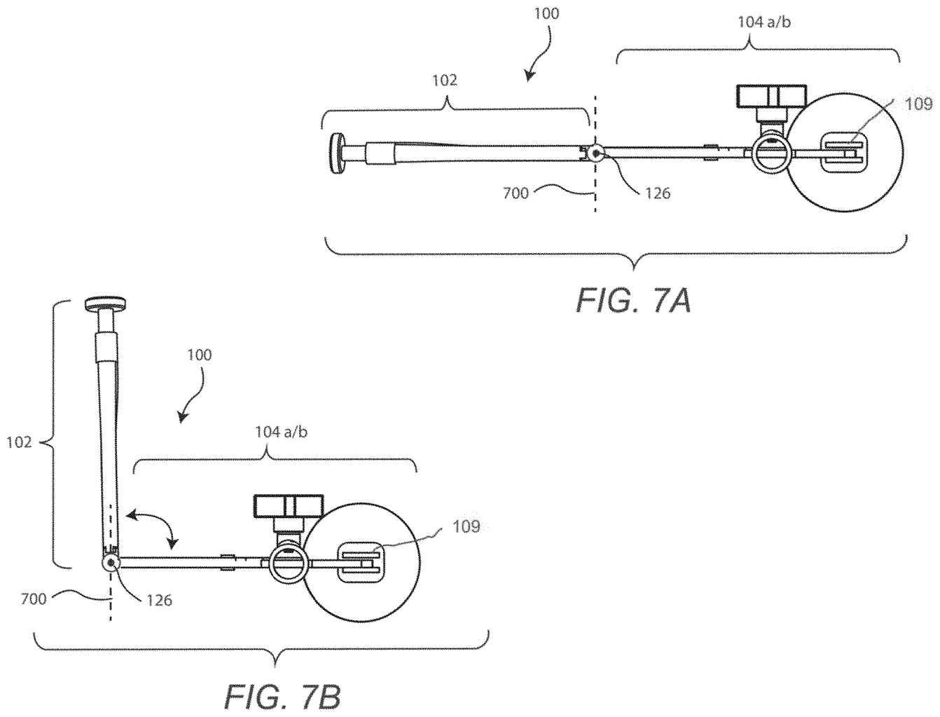

As shown in FIGS. 1A and 1B, handle portion 102 is comprised of a vice grip type handle. A user adjusts an adjustments screw 120 which ultimately controls the amount of pressure exerted by opposing clamps 106 and 108 when clamping portion 104a or 104b is clamped to a surface. In operation, a user adjusts adjustment screw 120, and then squeezes handle 122 until handle portion 102 locks clamping portion 104a or 104b to a desired surface. To release opposing clamps 106 and 108 from the surface to which they are clamped, a user depresses release lever 124. In one embodiment, handle portion 102 includes an adjustment joint that enables the position of handle portion 102 to be adjusted with respect to clamping portion 104a and 104b. This is described in detail below in conjunction with FIGS. 5A-5C and 6A-6C. Additionally, in various embodiments, handle portion 102 further includes a folding hinge 126 which enable handle portion 102 to be folded inward towards clamping portion 104a or 104b. This feature and functionality is described in detail below in conjunction with FIGS. 7A-7B.

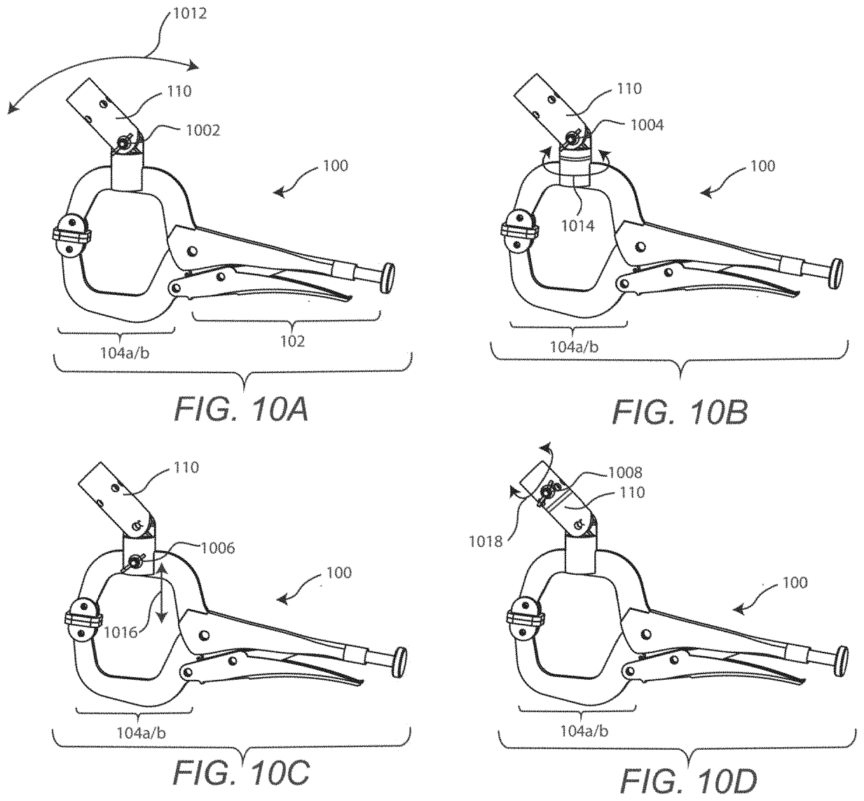

Referring still to FIGS. 1A and 1B, multi-functional clamping device 100 also includes an accessory mount 110 which is coupled to clamping portion 104a or 104b. Accessory mount 110 is configured to receive an accessory and retain the accessory in a desired position with respect to clamping portion 104a or 104b. As will be discussed in detail below in conjunction with FIGS. 10A-10D, the position of accessory mount 110 is adjustable with respect to clamping portion 104a or 104b. In one embodiment, accessory mount 110 is a “male” rod (not shown in FIGS. 1A and 1B) over which a “female” tube is situated. In one such embodiment, an accessory such as, for example, a vice grip has the female tube coupled thereto. In so doing, the vice grip is retained on accessory mount 110 in a desired position.

With reference again to FIGS. 1A and 1B, in the present embodiment, accessory mount 110 is a barrel or tube structure. As such, in the embodiment of FIGS. 1A and 1B, accessory mount 110 is a “female” mount, and accessory mount 110 is configured to receive a “male” post therein. As a result, the embodiments depicted in FIGS. 1A and 1B are configured to receive any accessory having the appropriate male post coupled thereto. It should be pointed out that in some embodiments, the “male” post is actually a female tube having a diameter which can fit inside the diameter of female accessory mount 110. Additionally, multi-functional clamping device 100 includes an accessory locking fixture 112 coupled to accessory mount 110. In the present embodiment, accessory locking device 112 is a screw having a handle coupled thereto. Accessory locking feature 112 is configured to secure an accessory to accessory mount 110 and prevent the accessory from moving about accessory mount 110. In such an embodiment, accessory mount 110 includes mounting or securing holes that accommodate a screw. It is appreciated that accessory mount 110 can be configured as any shape, size or be comprised of any of numerous materials. Additionally, in one embodiment, accessory mount 110 is removable and/or interchangeable. Further, accessory locking feature 112 and accessory mount 110 can be reciprocally configured to accommodate any number of methods to retain an accessory within accessory mount 110. Such methods include, but are not limited to locking pins, screws, magnets, press fit features, and so on.

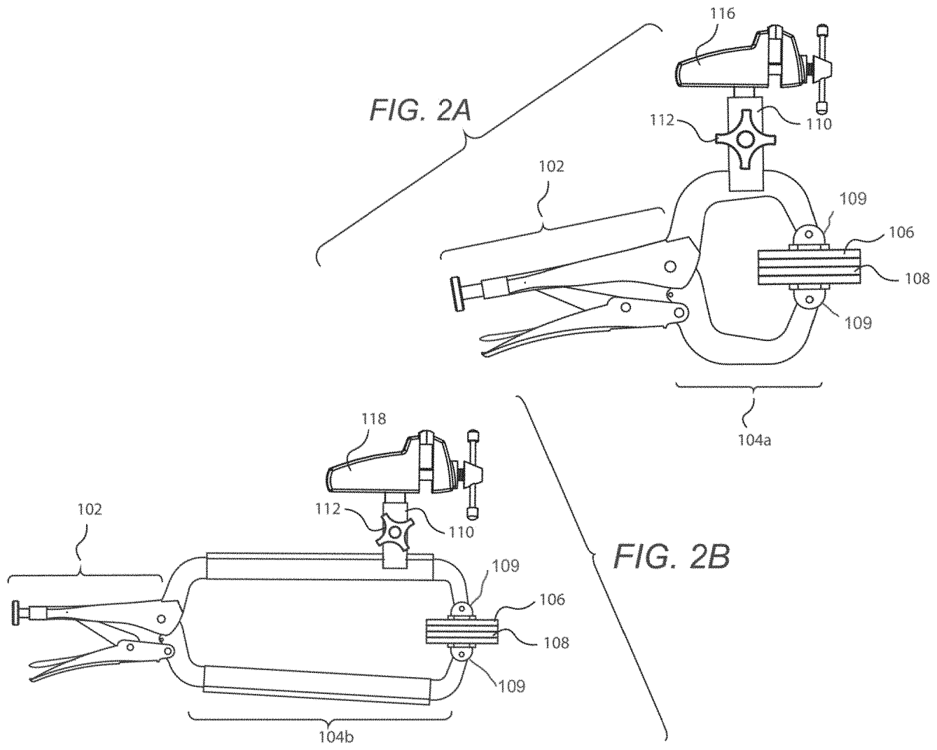

Referring now to FIGS. 2A and 2B, side views of embodiment of a multi-functional clamping device are shown accordance with the present claimed invention. Further, in FIGS. 2A and 2B, an accessory, in this example a vice 116 and 118, is coupled to accessory mount 110. After vice 116 and 118 are received in accessory mount 110, accessory locking feature 112 is tightened to securely retain vice 116 and 118 in accessory mount 110. Although vice 116 and 118 are shown in a particular orientation in FIGS. 2A and 2B, due to the adjustability of accessory mount 110 with respect to clamping portion 104a and 104b, the present invention is capable of retaining an accessory in virtually any number of positions and orientations. This feature of the present embodiments will be described in detail below in conjunction with FIGS. 10A-10D.

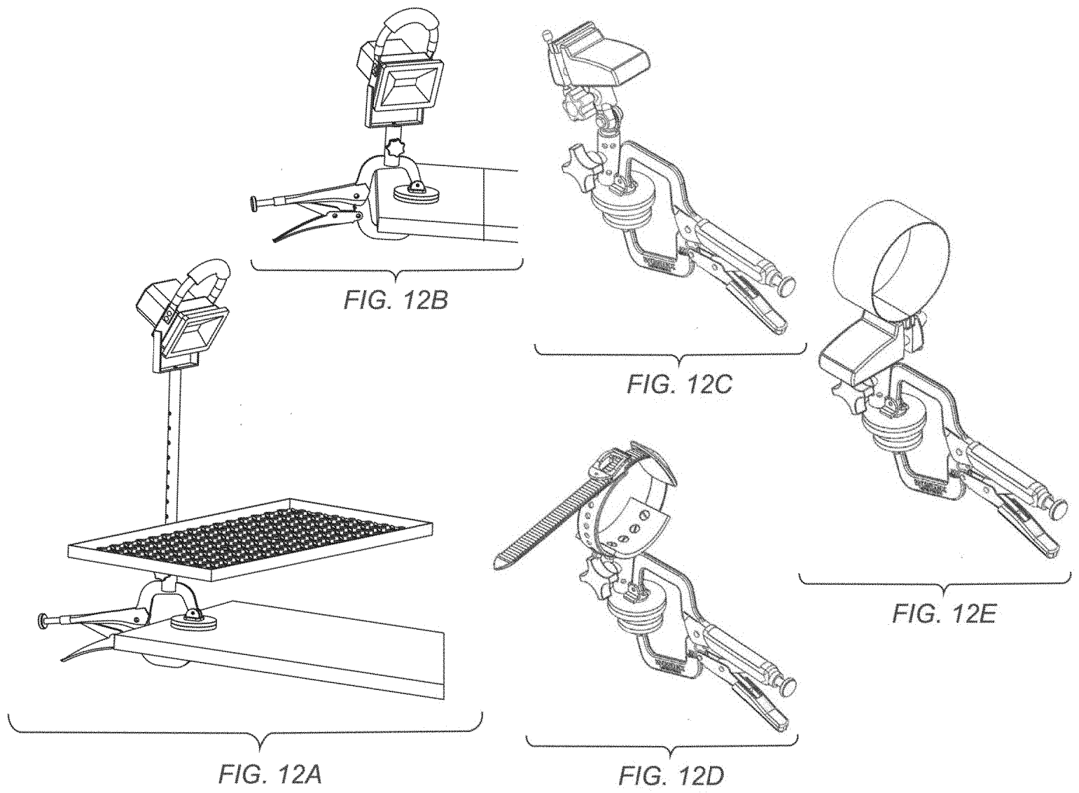

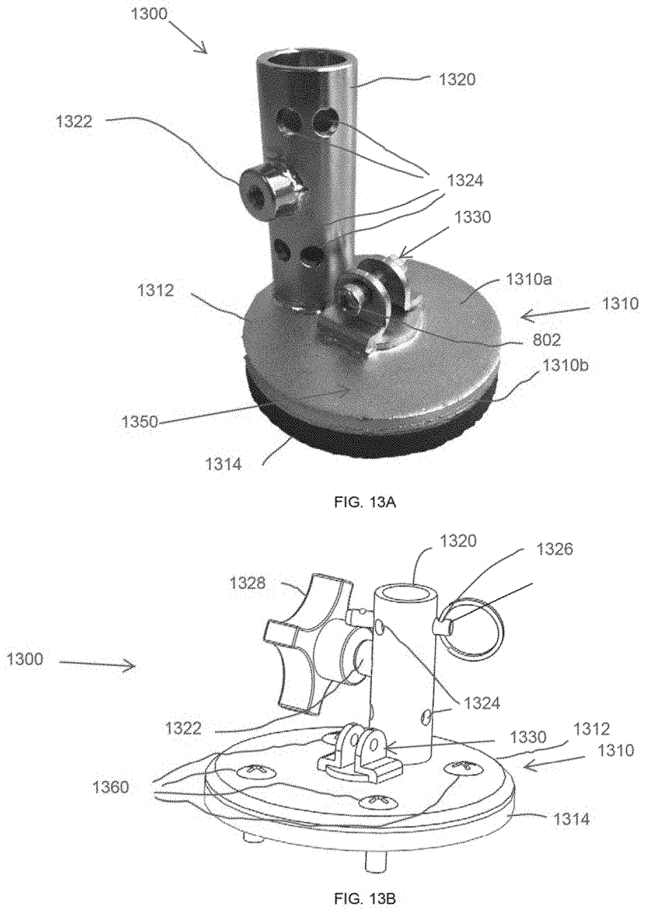

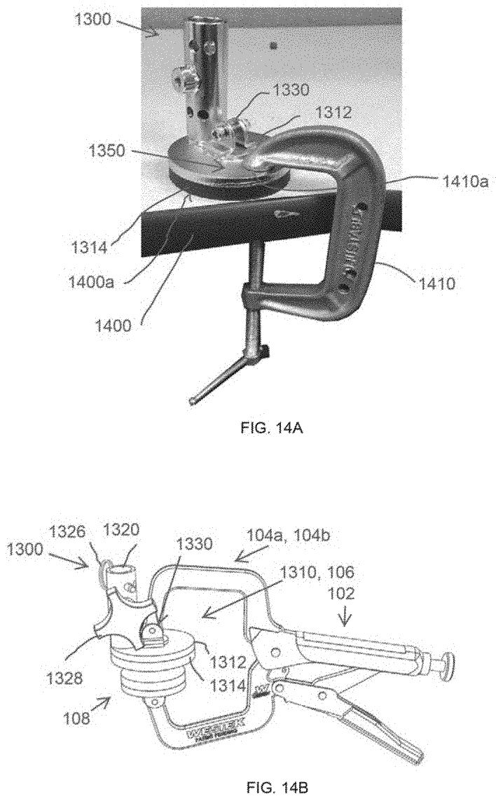

Referring still to FIGS. 2A and 2B, although a vice is shown in FIGS. 2A and 2B, any other type of accessory is also possible. For example, in one embodiment, the accessory is a tool used for telecommunications work such as soldering and wire splicing. In another embodiment, the accessory is a portable work surface, see for example FIG. 12A, such as a table or a specially configured work bench. In still another embodiment, the accessory is a mount for a fishing rod. In yet another embodiment, the accessory is a BBQ grill. Other accessories found in other embodiments include a flashlight, see for example FIGS. 12B and 12C, a phone, or any other item that a person would like to temporarily mount to a surface and retain in a desired position and orientation. The above list of accessories is meant only to provide examples of possible accessories, and is not meant to be an exhaustive or complete list of possible accessories.

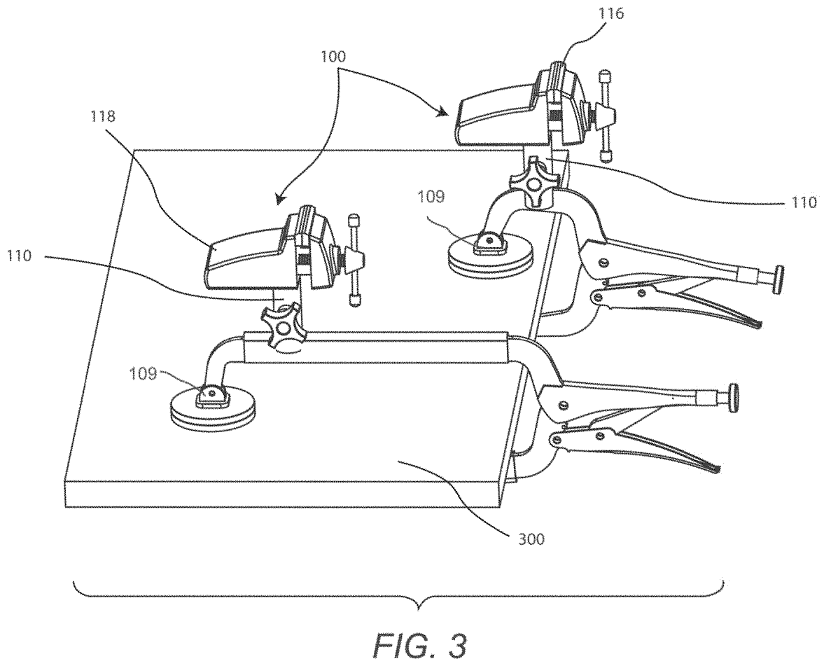

FIG. 3 shows a perspective view of two multi-functional clamping devices 100 in accordance with the present embodiments. In FIG. 3, each of the multi-functional clamping devices 100 is clamped to a table 300. Further, each multi-functional clamping device 100 has an accessory 116 or 118 coupled to its accessory mount 110. Although difficult to see in FIG. 3, as described above, a locking feature 112 is used to secure accessory 116 and 118 to its respective accessory mount 110. FIG. 3 is provided to show one example of an implementation of embodiments in accordance with the present invention.

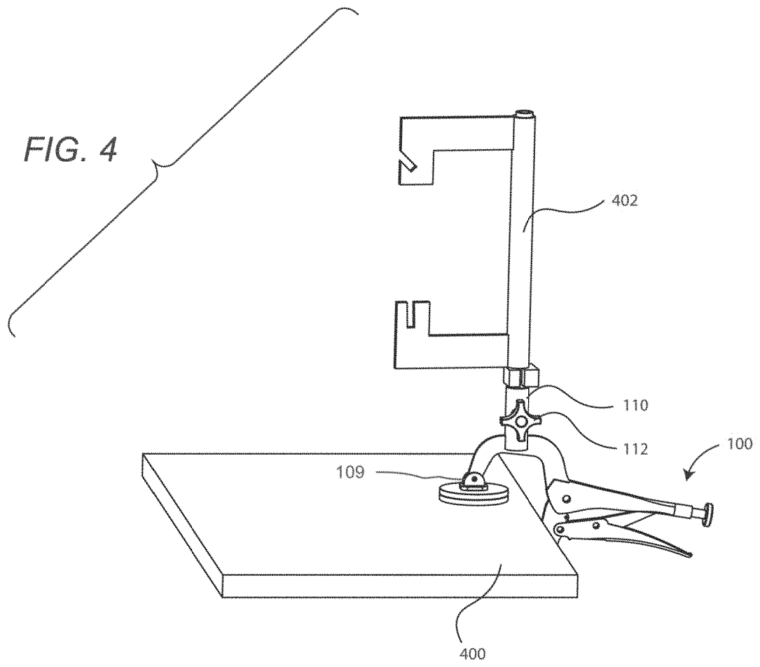

FIG. 4 shows a perspective view of a multi-functional clamping device 100 in accordance with the present embodiments. In FIG. 4, multi-functional clamping device 100 is clamped to a table 400 and has an accessory 402 coupled to accessory mount 110. Locking feature 112 is used to securely retain accessory 402 to accessory mount 110 and can allow 360 degree positioning. Again, FIG. 4 is provided to show one example of an implementation of embodiments in accordance with the present invention.

With reference now to FIGS. 5A-5C, side views of embodiments of multi-functional clamping device 100 are shown in accordance with the present claimed invention. In FIGS. 5A-5C, the position of handle portion 102 is shown is various positions with respect to clamping portion 104a. As shown in FIGS. 5A-5C, in various embodiments, handle portion 102 has an adjustment mechanism 502 that enables infinite adjustment of handle portion 102 with respect to the clamping portion 104a. In one embodiment, the vertical adjustment of handle portion 102 is accomplished using a series of removable locking support pins 502 and additional corresponding guide pin holes. In other embodiments, an additional vertical lock down swivel is added to handle portion 102. In so doing, handle portion 102 can be adjusted vertically along an infinite number of angles with respect to the clamping portion 104a. This allows a user to clamp clamping portion 104a to a desired surface, and then adjust the position of handle portion 102 to a desired angle with respect to clamping portion 104a. As a result, a user can move handle portion 102 to a position which is most convenient or desired for the user.

Referring now to FIGS. 6A-6C, side views of embodiments of multi-functional clamping device 100 are shown in accordance with the present claimed invention. In FIGS. 6A-6C, the position of handle portion 102 is shown is various positions with respect to clamping portion 104b. Similar to the description above regarding the embodiments of FIGS. 5A-5C, in FIGS. 6A-6C, in various embodiments, handle portion 102 has an adjustment mechanism 602 that enables infinite adjustment of handle portion 102 with respect to the clamping portion 104b. In one embodiment, the vertical adjustment of handle portion 102 is accomplished using a series of removable locking support pins 602 and additional corresponding guide pin holes. In other embodiments, an additional vertical lock down swivel is added to handle portion 102. In so doing, handle portion 102 can be adjusted vertically along an infinite number of angles with respect to the clamping portion 104b. This allows a user to clamp clamping portion 104b to a desired surface, and then adjust the position of handle portion 102 to a desired angle with respect to clamping portion 104b. As a result, a user can move handle portion 102 to a position which is most convenient or desired for the user.

With reference now to FIGS. 7A and 7B, schematic representations of top views of multi-functional clamping device 100 are shown. As described above, in various embodiments, handle portion 102 further includes a folding hinge 126. In FIG. 7A, handle portion 102 is in an open or unfolded position with respect to handle portion 104a or 104b (herein written as 104a/b). Further dotted line 700 is intended to represent the edge of a surface to which clamping portion 104a/b is clamped. In FIG. 7A, handle portion 102 would extend outward from edge 700 of the surface to which clamping portion 104 is clamped. In FIG. 7B, handle portion 102 is in a folded position with respect to handle portion 104a/b. More specifically, in FIG. 7B, after clamping portion 104a/b is clamped to the desired surface, handle portion 102 is folded, via hinge 126, inward towards clamping portion 104a/b. In so doing, handle portion 102 is moved towards edge 700. In some embodiments, handle portion 102 is nearly flush with edge 700 of the surface to which clamping portion 104a/b is clamped. As a result, in the present embodiment, during use a user can move handle portion 102 to a position which is most convenient or desired for the user. Specifically, rather than having handle portion 102 extend outward from edge 700 where handle portion may be in the way of the user (such as, for example, poking the user in the stomach), the user can now fold handle portion 102 via hinge 126, such that handle portion is no longer in an undesired location. It should be understood that embodiments in the course of the present invention can use any of numerous mechanisms to allow handle portion 102 to fold as described above.

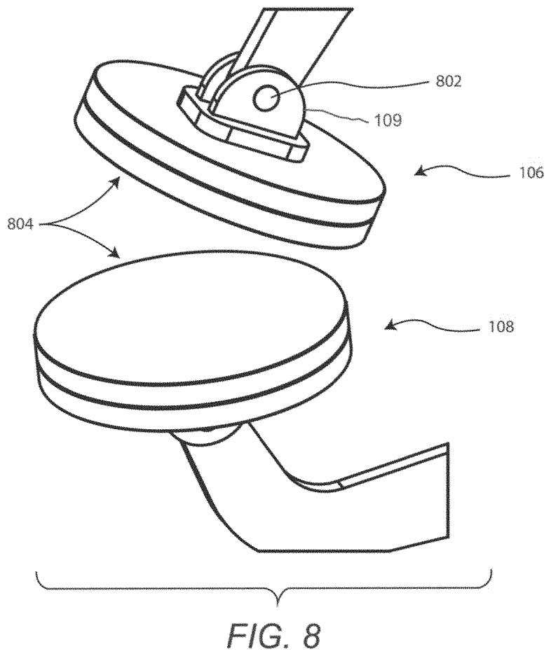

Referring next to FIG. 8, is a close up perspective view of two opposing clamps 106 and 108 of clamping portion 104a/b is shown in accordance with one embodiment of the present invention. In this embodiment, opposing clamps 106 and 108 are coupled to clamping arms via connectors 802 which allow movement or pivoting of opposing clamps 106 and 108. By allowing movement, embodiments of the present invention allow opposing clamps 106 and 108 to swivel to the proper position to best mate with the surface to which they are clamped. Connectors 802 can be screws, a gimbal mechanism, rivets, pins, or any other suitable component that allow movement of and/or replacement of opposing clamps 106 and 108. In so doing, embodiments of the present invention enable opposing clamps 106 and 108 to be removable. Although shown as removable in FIG. 8, the present invention is also well suited to embodiments in which opposing clamps are not removable or moveable. Returning to the embodiments of FIG. 8, in various embodiments, opposing clamps 106 and 108 are circular in shape. It should be noted, although shown as circular in the present embodiment, the present invention is well suited to having opposing clamps 106 and 108 formed of any of various shapes such as, but not limited to, circular, square, polyhedronal, or any other shape that is appropriate for a given use and/or surface. In one embodiment, multi-functional clamping device 100 utilizes rounded opposing clamps to provide more surface area for clamping. Such an approach is particularly useful on surfaces where the clamping force needs to be distributed over a greater area to prevent damage. Further, although opposing clamps 106 and 108 appear to be the same size as shape in FIG. 8, embodiments in accordance with the present invention are well suited to having opposing clamps 106 and 108 with differing sizes, shapes, or materials.

Referring still to FIG. 8, in one embodiment, opposing clamps 106 and 108 have a rubber or other compliant material applied to the clamping surface 804 thereof to achieve a padded clamping surface 804. The padded clamping surface 804 helps to provide additional gripping force between opposing clamps 106 and 108 and the surface to which they are clamped. Further, in one embodiment, the gripping material on clamping surface 804 of opposing clamps 106 and 108 is selected to be a material which will not damage the surface to which multi-functional clamping device 100 is being clamped. Additionally, using a gripping material on opposing clamps 106 and 108 enables multi-functional clamping device 100 to grip uneven or textured surfaces. Materials used on clamping surface 804 of opposing clamps 106 and 108 include but are not limited to felt, rubber, metal, wood, fabric, a non-slip pliable material, an electrically insulated material, a textured material, etc. Again, the above list is not intended to be exhaustive. Also, in one embodiment, opposing clamps 106 and 108 include a magnet that provides a magnetic force between opposing clamps 106 and 108 and the surface to which they are being clamped.

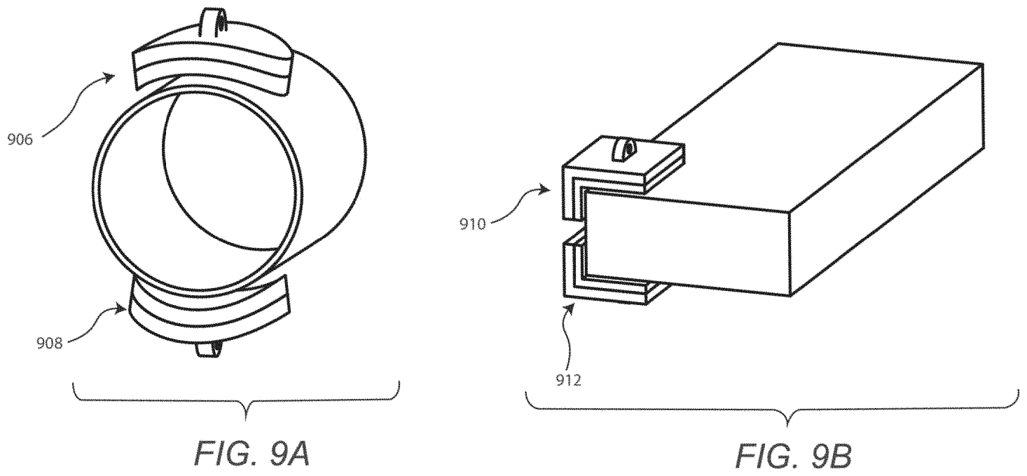

Referring now to FIGS. 9A and 9B, perspective views of opposing clamps (906 and 908) and (910 and 912) having a non-flat clamping surface in accordance with present embodiments are shown. It should be noted, that the present invention is well suited to having opposing clamps formed with any of various clamping surface shapes that is appropriate for a given use and/or surface. Further, although opposing clamps (906 and 908) and (910 and 912) appear to have matching clamping surface shapes in FIGS. 9A and 9B, embodiments in accordance with the present invention are well suited to having opposing clamps wherein each opposing clamp has a different clamping surface shape. That is, the present invention is well suited to an embodiment wherein one opposing clamp has a rounded clamping surface and the other opposing clamp has a non-rounded clamping surface.

Referring still to FIGS. 9A and 9B, by having non-flat clamping surfaces, the present invention is well suited to using multi-functional clamping device on surfaces such as, for example, a boat rail, a truck tailgate, a fence post, a telephone pole, and so on. Thus, by tailoring the shape, size, and/or clamping surface of opposing clamps, the present multi-functional clamping device has an almost unlimited ability to be used in innumerable environments.

With reference next to FIGS. 10A-10D, perspective views of an embodiment of multi-functional clamping device 100 in accordance with the present claimed invention is shown in which the position of accessory mount 110 is adjustable with respect to clamping portion 104a/b. FIG. 10A shows an adjustable position accessory mount 110 that has a set screw 1002 for enabling accessory mount 110 to be swiveled any number of angles (as depicted by arrow 1012) with respect to clamping portion 104a/b. In so doing, an accessory retained in accessory mount 110 can be located leaning forward away from handle portion 102. Conversely, an accessory can be swiveled back toward handle portion 102. Referring now to FIG. 10B, the location of set screw 1004 enables rotation of accessory mount 110 as depicted by arrow 1014. In so doing, accessory mount 110 would sweep through a cone whose shape would depend on the angle of accessory mount 110 with respect to clamping portion 104a/b. Referring now to FIG. 10C, the location of set screw 1006 enables upward or downward movement of accessory mount 110 as depicted by arrow 1016. In so doing, accessory mount 110 is moved nearer to or farther from clamping portion 104a/b. Referring now to FIG. 10D, the location of set screw 1008 enables rotation of accessory mount 110 as depicted by arrow 1018. In so doing, accessory mount 110 would rotate with respect to clamping portion 104a/b. Importantly, in some embodiments of the present invention, combinations of the adjustments described above are used together. In so doing, an accessory received in accessory mount 110 can be moved through several axes of motion and can be retained in an infinite number of positions relative to clamping portion 104a/b.

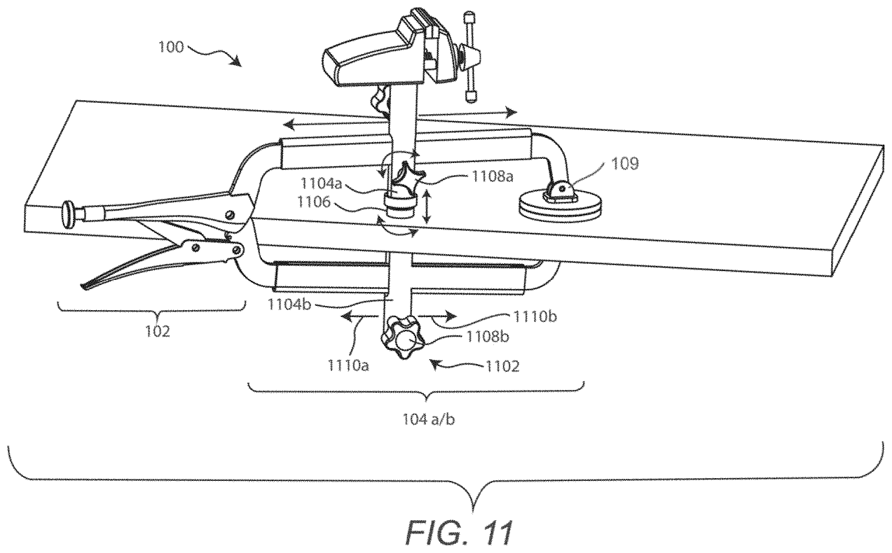

FIG. 11 is a perspective view of an embodiment of multi-functional clamping device 100 in accordance with the present claimed invention including a support fixture 1102 coupled to clamping portion 104a/b. In the present embodiment, support fixture 1102 includes bracing posts 1104a and 1104b, a tensioner 1106, and adjustment knobs 1108a and 1108b. In operation, in order to ensure that clamping portion 104a/b remains in a fixed location with respect to the surface to which it is clamped, support structure 1102 is utilized. Specifically, bracing posts 1104a and 1104b keep the arms of clamping portion 104a/b in a desired position. Although, support fixture 1102 of the present embodiment has both top and bottom bracing posts 1104a and 1104b, the present invention is also well suited to an embodiment in which only a top bracing post 1104a or only a bottom bracing post 1104b is used. In this embodiment, a top tensioner 1106 is used to contact the top surface to which multi-functional clamping device is clamped. By contacting the top surface, tensioner 1106 and bracing post 1104a keep the top portion of clamping portion 104a/b in a desired location. Similarly, a bottom tensioner, hidden, is used to contact the bottom surface to which multi-functional clamping device is clamped. By contacting the bottom surface, bottom tensioner, hidden, and bracing post 1104b keep the bottom portion of clamping portion 104a/b in a desired location.

Referring still to FIG. 11, in one embodiment of the present invention, the position of support fixture 1102 is adjustable. In such an embodiment, adjustment knobs 1108a and 1108b are used to move bracing posts 1104a and 1104b, respectively, to a desired location along clamping portion 104a/b as shown by arrows 1110a and 1110b. It should be understood, however, that in some embodiments, support fixture 1102 is not adjustable.

### Portable Workstation Platform

In some embodiments, a portable workstation platform is provided that may be clamped or screwed or otherwise fastened into any vertical or horizontal or off-angle mounting point to allow the connection of such tools as a vice clamp, a work tray, a bracket support, equipment and or a tube or whatever needs to be supported. FIGS. 13A-13B are each a perspective view of the workstation platform 1300, which includes a base 1310. The base 1310 has a first surface 1310a and a second surface 1310b. An accessory mount 1320 is secured to the first surface 1310a of the base 1310. An accessory locking feature 1322 is coupled to the accessory mount 1320. A pair of clamp fastening tabs 1330 are secured to the first surface 1310a of the base 1310.

The accessory mount 1320 may include multi-positioning holes 1324 that are configured to receive a positioning pin 1326, such as shown in FIG. 13B. The multi-positioning holes 1324 may be located at appropriate positions on the side of the accessory mount 1320. Such multi-positioning holes 1324 may have corresponding holes on the opposite side of the accessory mount 1320 for receiving an alignment pin 1326 that passes through a hole in the male post of an accessory unit, as shown in FIG. 13B. The placement and number of positioning holes 1324 is a matter of design choice.

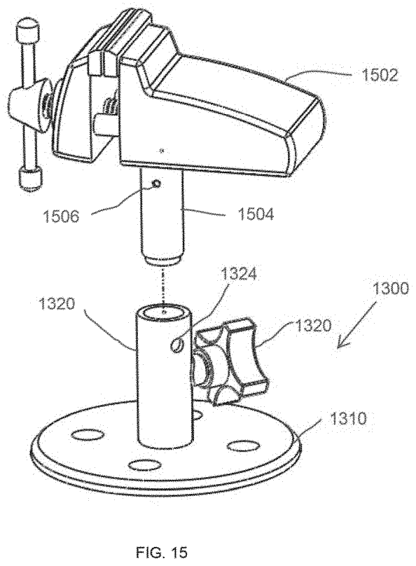

The accessory mount 1320 may be configured to receive an accessory, such as vise 116 or 118, accessory 402, portable work surface (e.g., FIG. 12A), such as a table or a specially configured work bench, mount for a fishing rod, BBQ grill, flashlight (e.g., FIGS. 12B and 12C), a phone, or any other item that a person would like to temporarily mount to a surface and retain in a desired position and orientation, as described above. Accessory mount 1320, which is similar to accessory mount 110 described above, is configured to receive the accessory and retain the accessory in a desired position. For example, FIG. 15 depicts a vise 1502 in position to be inserted into the accessory mount 1320.

The accessory locking feature 1322 may be configured to threadably receive a fastener knob 1328, as shown in FIG. 13B. The fastener knob 1328 may prevent the accessory from moving about the accessory mount.

The accessory mount 1320 is a point of contact such as by a screw (e.g., fastener knob 1328), pin (e.g., alignment pin 136) or other form of securing the accessory that is being inserted into the accessory mount 1320. This method of contact allows for rotation and vertical movement for proper aligning. Once that positioning is found, the method of contact with them be tightened or inserted to lock the accessory in place.

In one embodiment, accessory mount 1320 is a “female” barrel or tube configured to accept a “male” rod or post. As a result, the embodiments depicted in FIGS. 13A and 13B are configured to receive any accessory having the appropriate male post coupled thereto. It should be pointed out that in some embodiments, the “male” post may actually be a female tube having a diameter which can fit inside the diameter of female accessory mount 1320.

Accessory locking feature 1322 is configured to secure an accessory to accessory mount 1320 and prevent the accessory from moving about accessory mount 1320. In such an embodiment, accessory mount 1320 includes mounting or securing holes that accommodate a screw. It is appreciated that the accessory mount 1320 can be configured as any shape, size or be comprised of any of numerous materials. Further, accessory locking feature 1322 and accessory mount 1320 can be reciprocally configured to accommodate any number of methods to retain an accessory within accessory mount 1320. Such methods include, but are not limited to locking pins, screws, magnets, press fit features, and so on.

The clamp fasting tabs 1330 are similar to the clamp fastening tabs 109 described above. The connectors 802, shown in FIG. 8, may be screws, as shown in FIG. 13A.

The first surface 1310a may further include a generally flat area, indicated generally at 1350, for receiving a top portion of a C-clamp. FIG. 14A depicts the portable workstation platform 1300 clamped to a surface 1400a of a workbench 1400 by an external C-clamp 1410 or other clamping device. A top portion 1410a of the C-clamp 1410 is in clamped contact with a portion of the flat area 1340 of the portable workstation platform 1300 by way of a small flat edge at the top of the C-clamp.

FIG. 13B shows fastener knob 1328 and alignment pin 1326. FIG. 13B also depicts an alternate embodiment for fastening the portable workstation platform 1300 to a surface, namely, surface mounting hardware 1360, such as screws or bolts. This embodiment allows the portable workstation platform 1300 to be secured to a surface without the need for a clamp.

The base 1310 may comprise a relatively rigid portion 1312 with a layer of a padding material, or cushioning pad, 1314 on the second surface 1310b of the base opposite the first surface 1310a. An example of the padding material is styrene butadiene rubber, although other materials having similar properties may also be employed in the practice of the embodiments. The cushioning pad 1314 is configured for non-marring purposes on painted or delicate surfaces. The screw holes for receiving screws 1360 protrude through the cushioning pad 1314 when used.

The various metal components of the portable workstation platform 1300, such as the base 1310, the accessory mount 1320, and the pair of clamp fastening tabs 1330 may be made of nickel-plated steel or other suitable material. The accessory mount 1320 and the pair of clamp fastening tabs 1330 may be mounted to the base 1310 by welding, for example.

In a separate embodiment, the workstation platform 1300 is essentially formed on one of the opposing clamps 106, 108. As shown in FIG. 14B, the workstation platform 1300 is formed on a surface 106a of clamp 106, which includes relatively rigid portion 1312 and cushioning pad 1314. The pair of clamp fastening tabs 1330 is configured to receive any of the multi-functional clamping devices 100 described above. In this embodiment, the handle portion 102 comprises the vice grip handle. The clamping portion 104a, 104b is coupled to the handle portion 102. The clamping portion 104a, 104b comprises opposing clamps 106, 108. Specifically, in this embodiment, one of the clamps, here, clamp 106 comprises the base 1310.

FIG. 14B illustrates the combination of the multi-functional clamping device 100 depicted in FIG. 1A and the portable workstation platform 1300 depicted in FIG. 13. The clamping portion is denoted as 104a, 104b, which is taken to mean that either the clamping portion 104a shown in FIGS. 1A and 2A may be used or the clamping portion 104b shown in FIGS. 1B and 2B may be used.

FIG. 15 depicts a vise 1502 with a downwardly depending post 1504 for insertion into the accessory mount 1320. The downwardly depending post 1504 includes a hole 1506 to be aligned with multi-positioning hole 1324 for insertion of an alignment pin (not shown) therethrough.

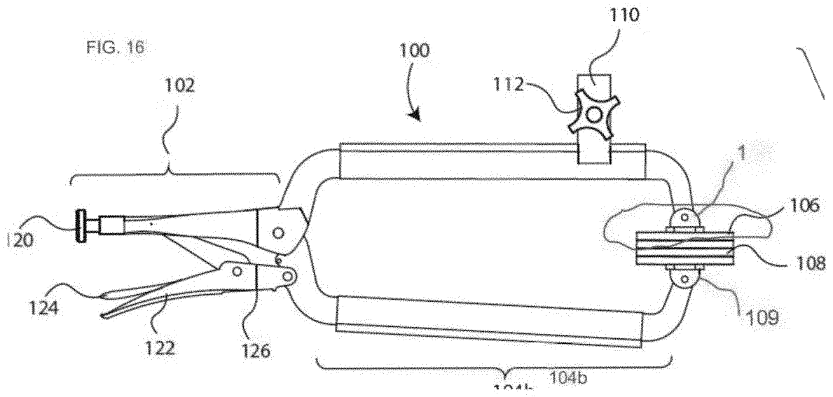

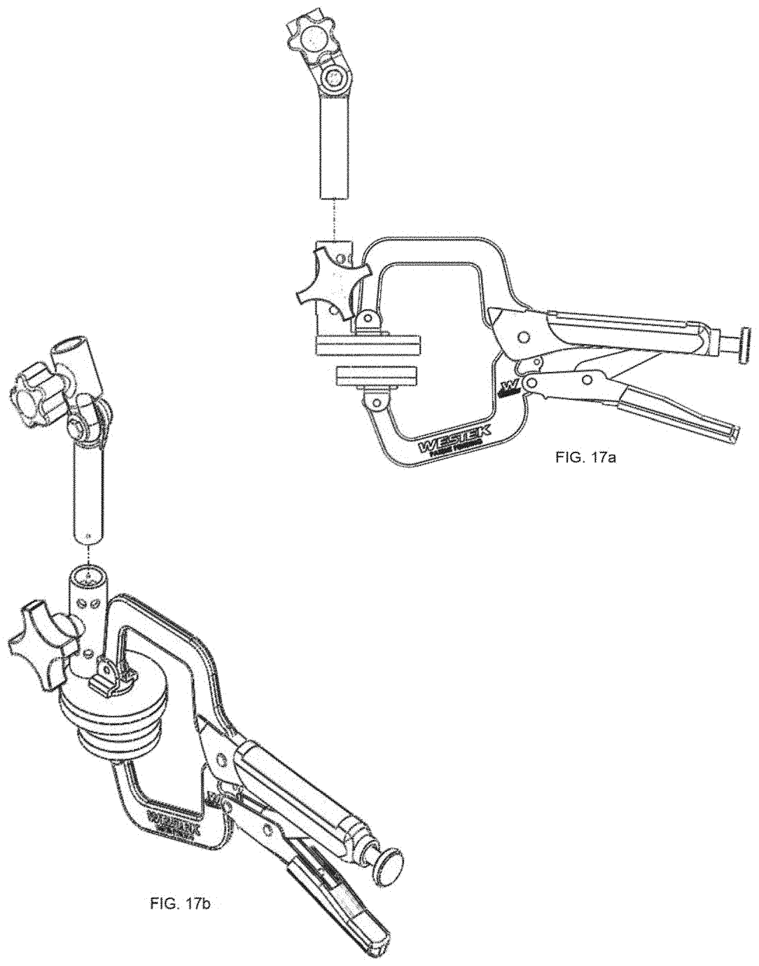

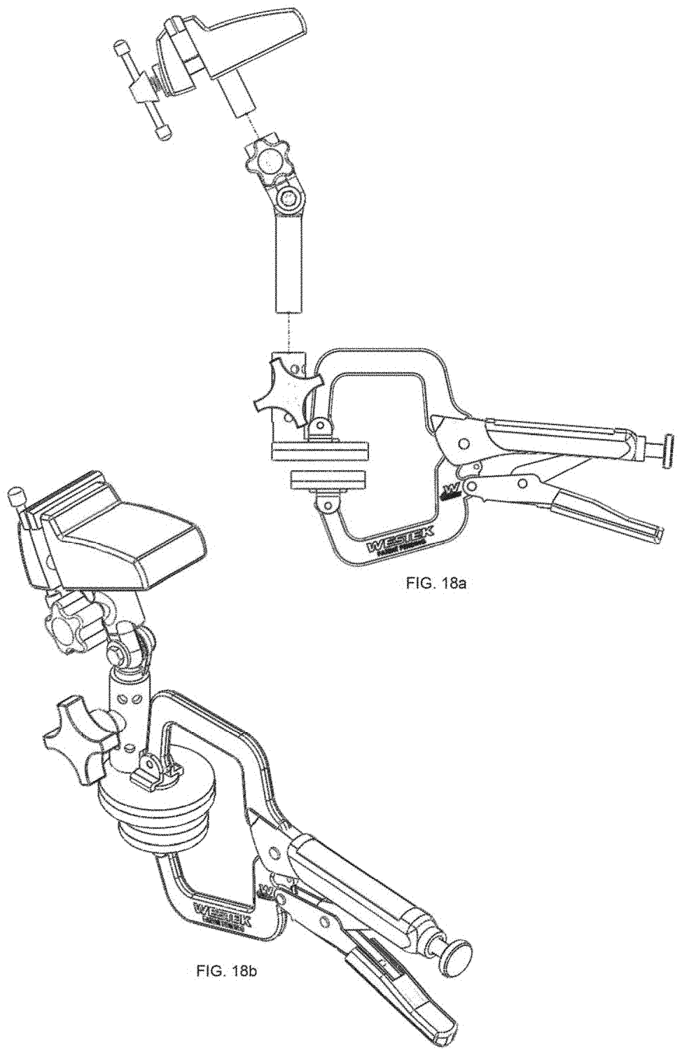

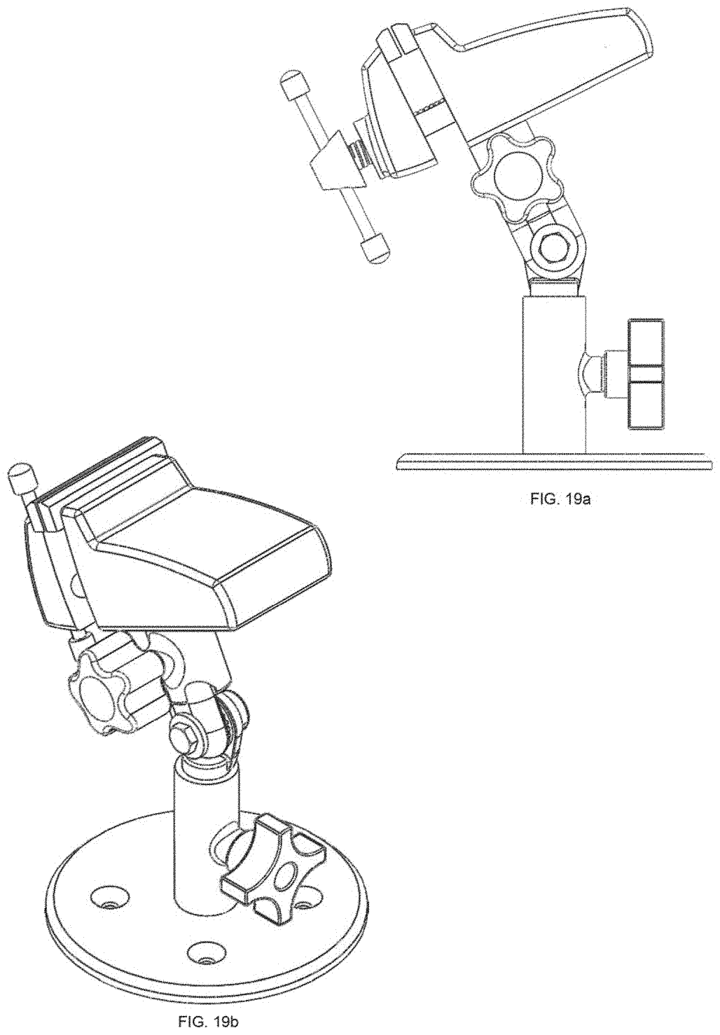

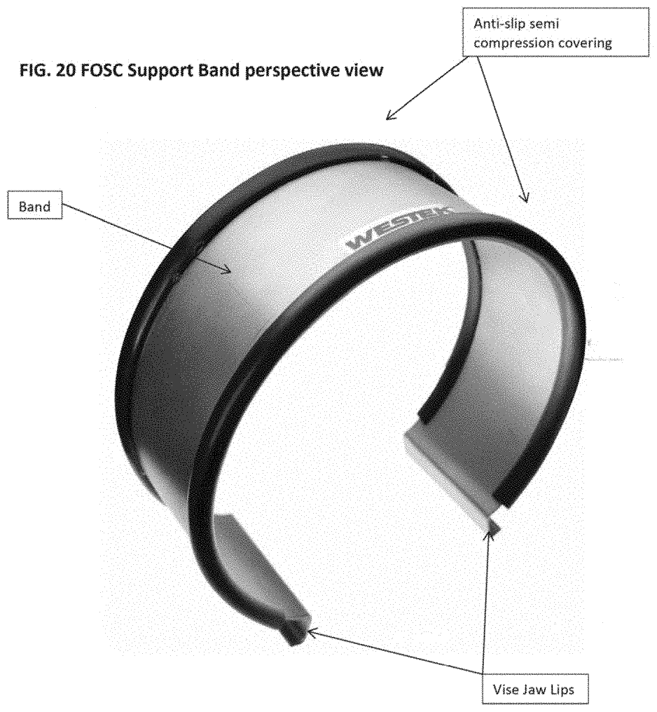

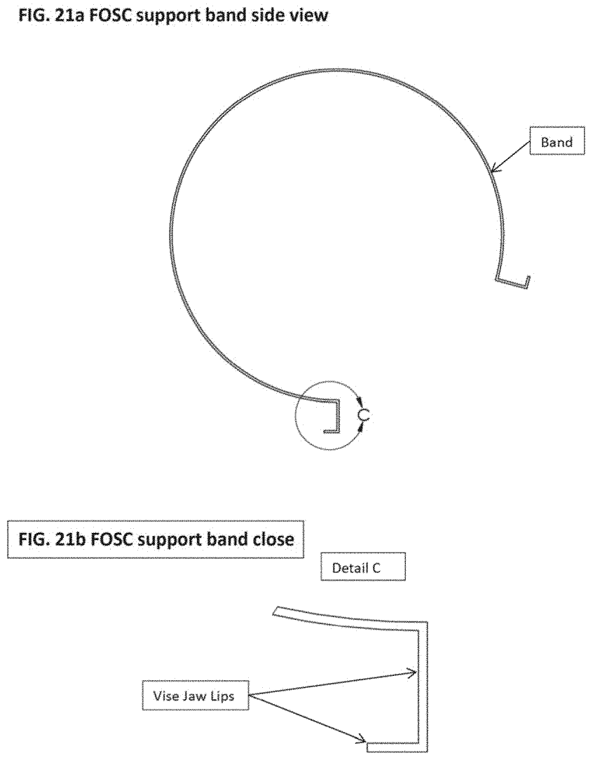

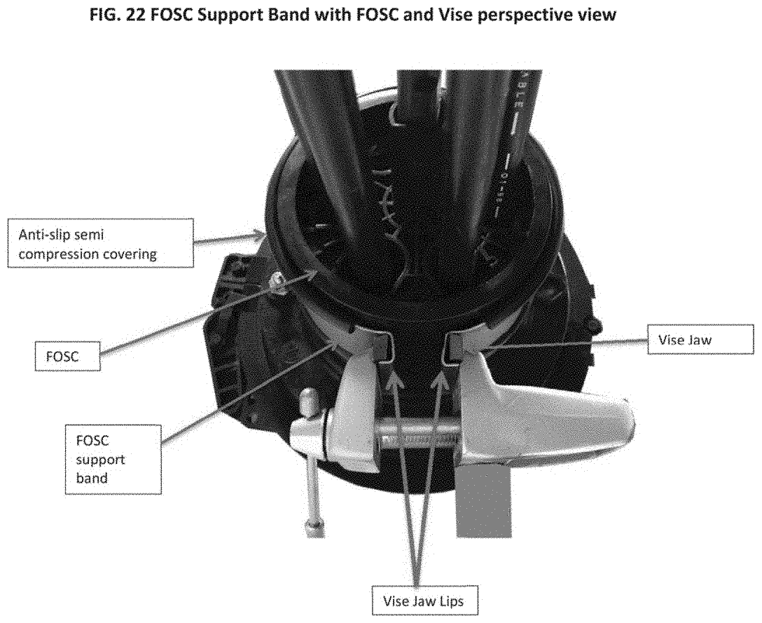

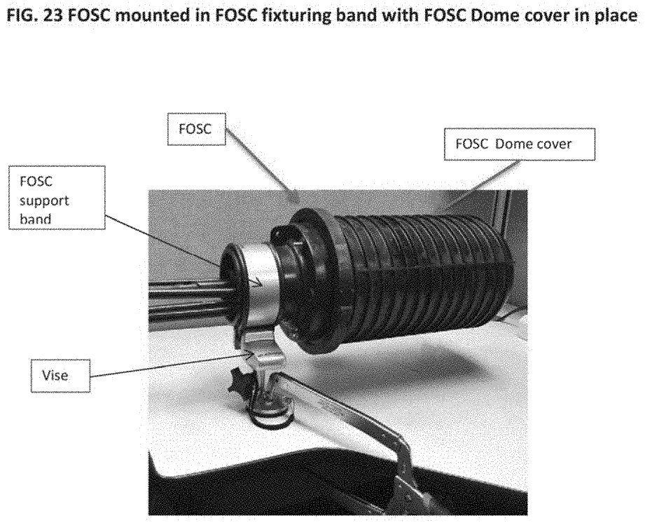

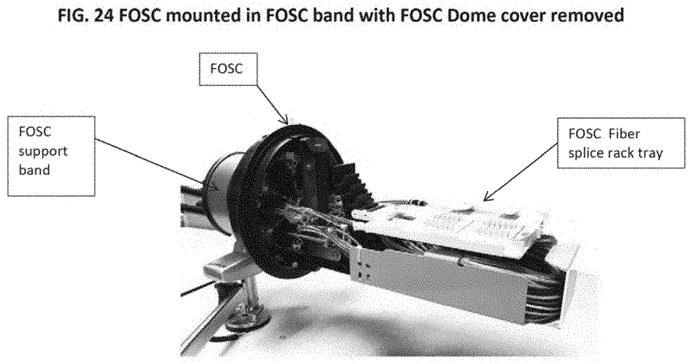

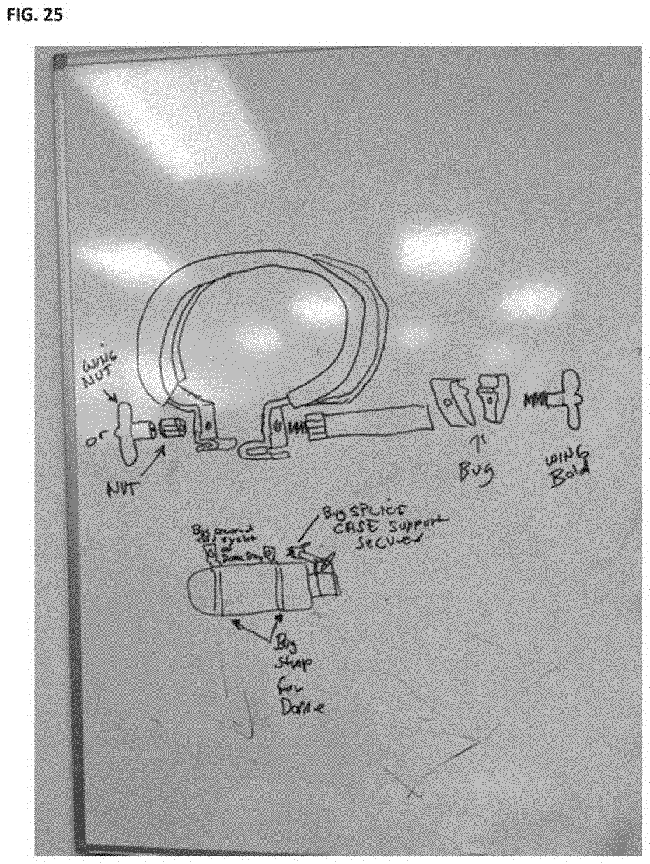

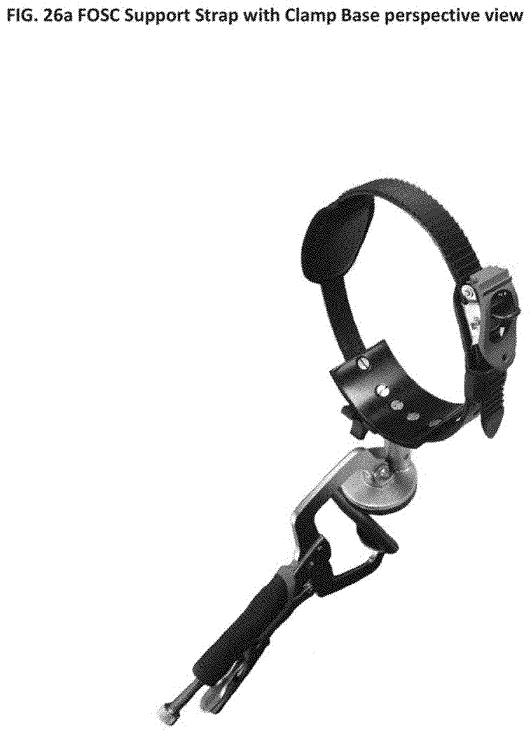

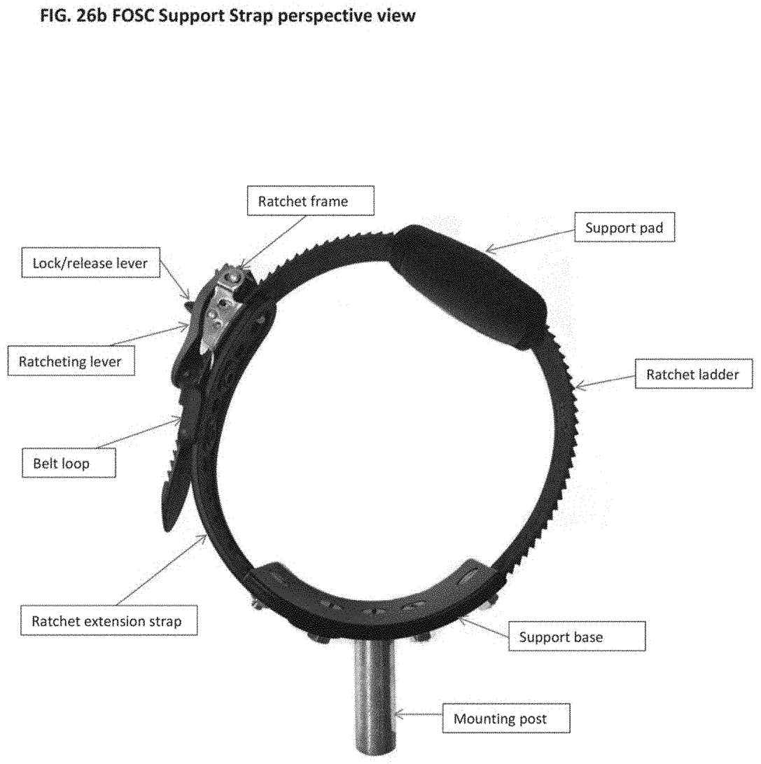

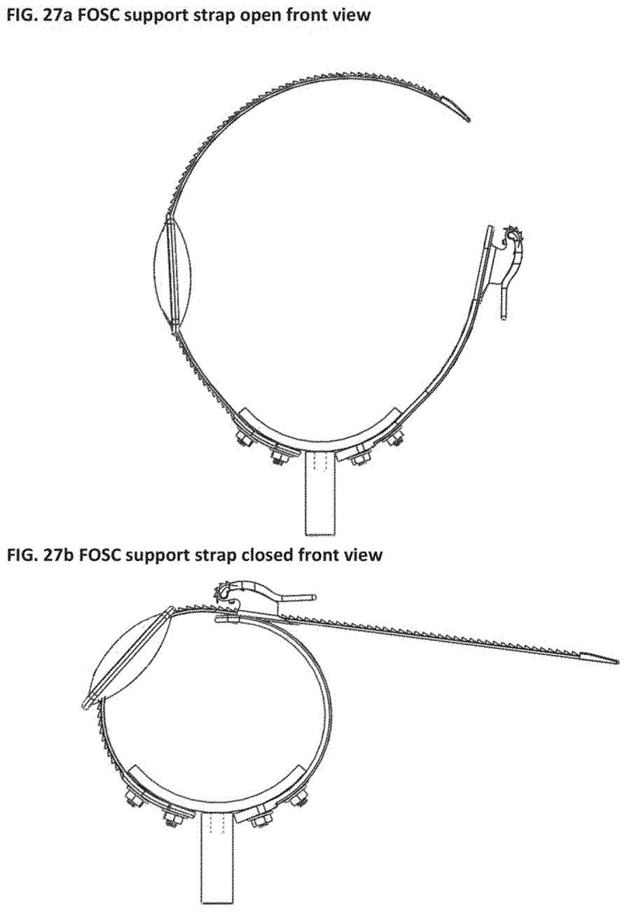

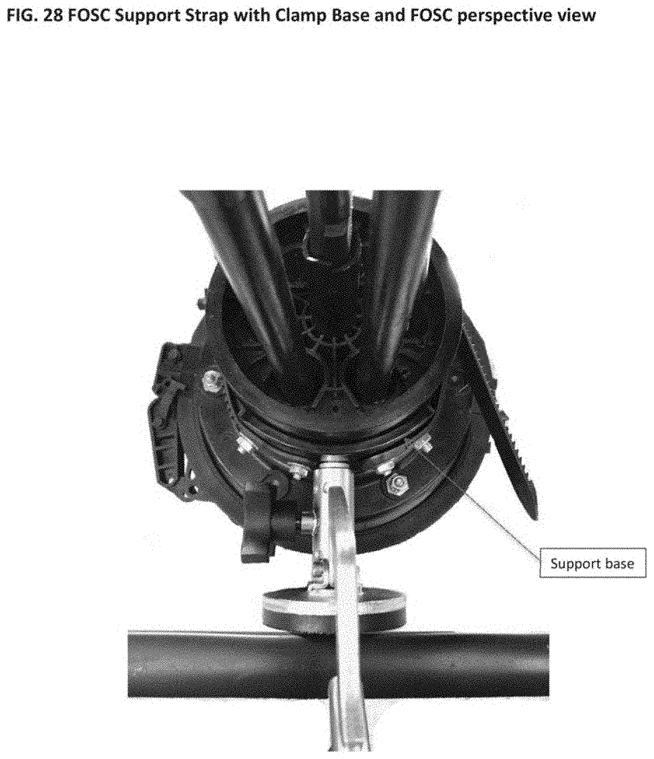

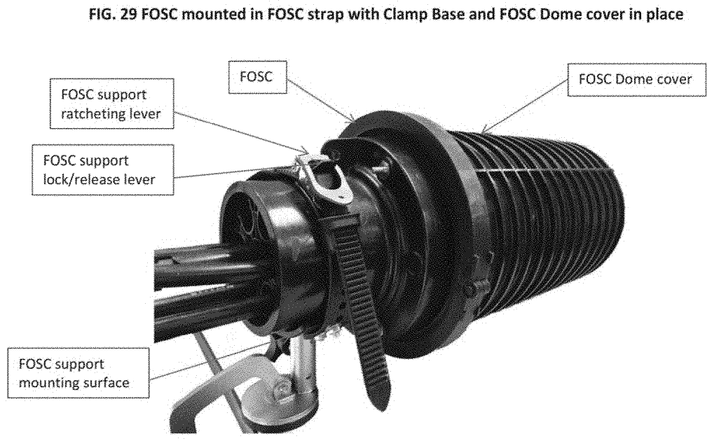

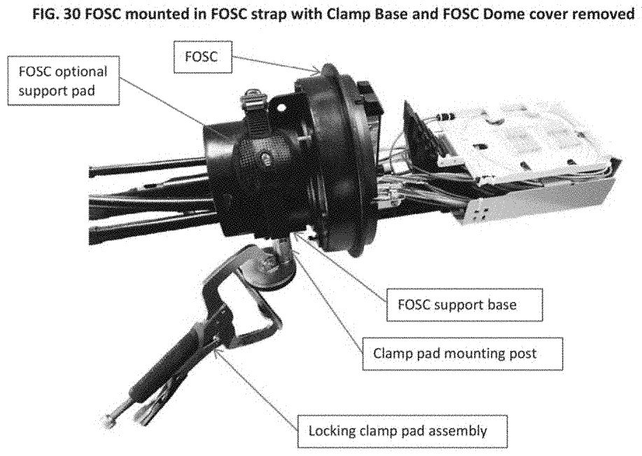

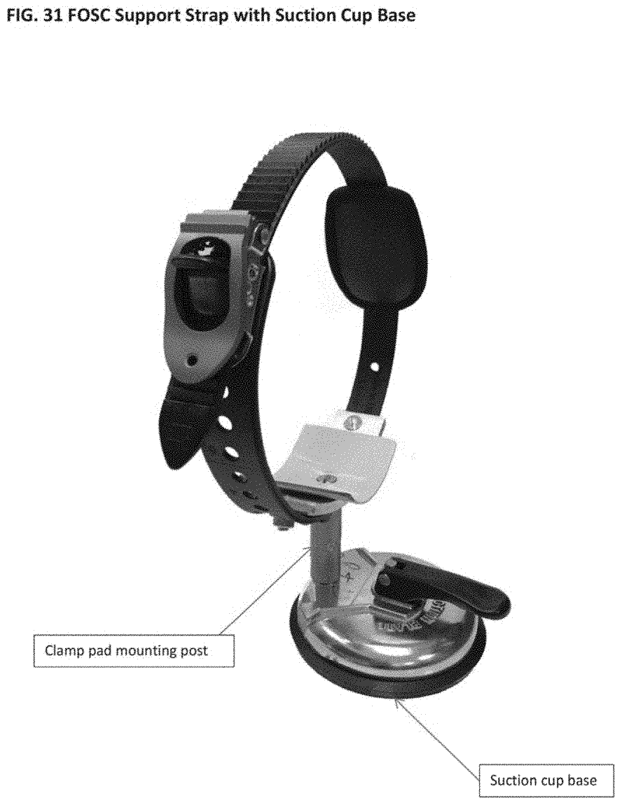

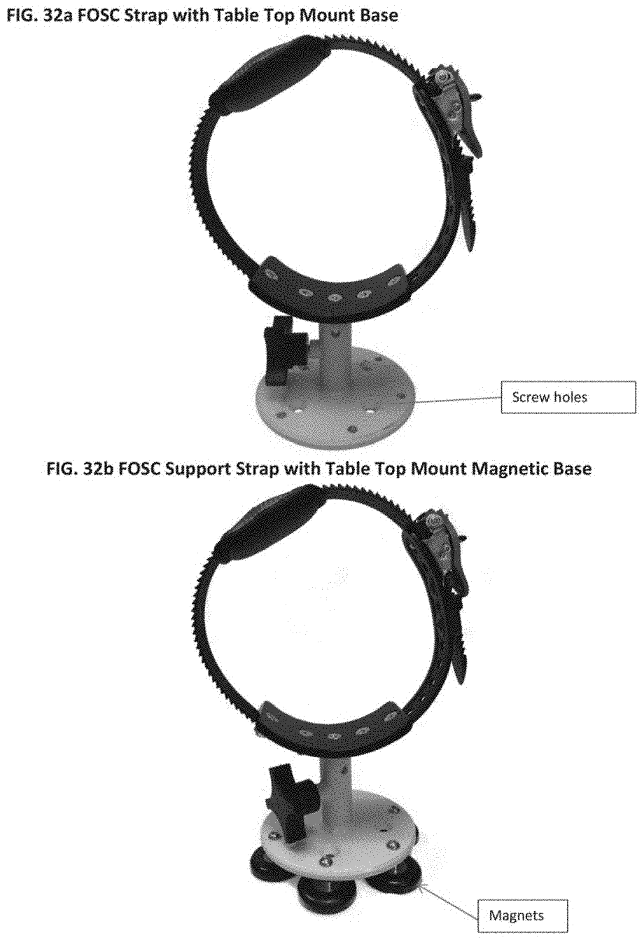

The combination of the portable workstation platform 1300 and the multi-functional clamping device 100 has depicted one of the clamps, here, 106, as comprising the portable workstation platform, with the accessory mount 1320 (a first accessory mount). However, it will be appreciated that the multi-functional clamping device 100 may also include an accessory mount 110 (second accessory mount) on the clamping bar 104a, 104b. FIG. 16 depicts such a combination. In this case, the elongated clamping bar 104b of FIGS. 1B, 2B is specifically depicted, but the shorter clamping bar 104a of FIGS. 1A, 2A may also be used.

The purpose of this invention is to create a more user friendly and safer work environment for the Fiber Optic Technician who works with FOSC Splice cases.

In today's fiber world, the fiber cable is an upgraded replacement to the old copper cords of yester year. As we all know and have observed copper telephone lines are all around our world. Copper telephone lines are visual when connected to the above ground telephone poles. The not visible telephone lines are called buried cable or cables. The buried cable is accessed in the underground areas through a manhole, Vault or other means of access.

Copper and fiber optic cable all have one thing in common. The individual conductors whether copper or glass need to be spliced or connected in some means to continue to carry circuit packets or communications data and voice from the equipment end to end. The means of connection of the cases and the conductors and type of connections may differ. The mentioned cable lengths need to be connected together to provide continuous communications while also acting as cable to cable connection point and strain relief.

The connections points where these splice cases are found is at any point where one cable needs to be connected to another length of cable. An example is that cables are always provided on spools or some other means of packaging for shipping. Once the cables arrive at the location. The cable is then taken off the spool in desired lengths. The lengths of cable, whether copper or fiber need to be connected, whether it is to be hung in the air or buried underground. The cable is then pulled and unrolled and run up a telephone pole or put down into a trench or manhole where it is pulled into place. One end of the cable can be spliced to another cable and then multiple other cable lengths to reach the span desired. Before the cable is hooked up to the equipment on each end, the individual cable lengths are connected together and the internal fibers are spliced together to complete that cable length. The connection of the heavy fiber cables and their internal fibers are all connected into the splice case that is designed to protect, secure and mate the two cable ends together. The splice cases can be easily identified when hung in the air between poles. The splice case is a black or silver round or oval enclosure that is either axial or radial.

When these end-to-end cable connections are performed, the splice or connections need to be supported during the process. This invention has to do with just that. The splice cases can and do house internally, the blocks, jacks, terminals, splice trays and any other means of supporting and protecting the connection. The loose fibers conductors whether single or multiple, ribbon or flat. These loose conductors whether loose tube, single fiber or multi fiber (ribbon) cables are routed and secured into fiber trays or an equivalent means of protecting the connection points.

This invention has to do with the support of these splice cases when being installed and or serviced, repaired or increased in capacity.

The purpose of this invention is to create a more user friendly and safer work environment for the Fiber Optic Technician who works with Fiber Optic Splice cases (FOSC).

In today's fiber world, the fiber cable is an upgraded replacement to the old copper cords of yester year. As we all know and have observed, copper telephone lines are all around our world. Copper telephone lines are visual when connected to the above ground telephone poles. The hidden telephone lines are buried underground and accessed by way of a manhole, vault, or other means.

Copper and fiber optic cable all have one thing in common. The individual conductors, whether copper or glass, need to be spliced or connected in some means to continue to carry circuit packets or communications data from the equipment end to end. The means of connection of the cases, the conductors, and type of connections may differ. The mentioned cable lengths need to be connected together to provide continuous communications while also acting as cable to cable connection point and strain relief.

The connection points where these splice cases are found are at any point where one cable needs to be connected to another length of cable. Cables are always provided on spools or similar means of packaging for shipping purposes. Once the cables arrive at the location, the cable is then taken off the spool in desired lengths. The lengths of cable, whether copper or fiber, need to be spliced together, whether they are to be hung in the air or buried underground. The cable is unrolled and run up a telephone pole or put down into a trench or manhole where it is pulled into place. One end of the cable can be spliced to another cable and then multiple other cable lengths to reach the span desired. Before the cable is hooked up to the equipment on each end, the individual cable lengths are connected together and the internal fibers are spliced together to complete that cable length. The connection of the heavy fiber cables and their internal fibers are all connected into the splice case that is designed to protect, secure, and mate the two cable ends together. The splice cases can be easily identified when hung in the air between poles. The splice case is a black or silver round or oval enclosure.

When these end-to-end cable connections are performed, the splice or connections need to be supported during the process. This invention has to do with just that. The splice cases can and do house internally the blocks, jacks, terminals, splice trays, and any other means of supporting and protecting the connection. These loose conductors, whether loose tube, single fiber or multi fiber (ribbon) cables are routed and secured into fiber trays or an equivalent means of protecting the connection points.

This invention has to do with the support of these splice cases when being installed and or serviced, repaired or increased in capacity.

Hence, embodiments in accordance with the present invention create a unique portable workstation platform which enables any accessory to be received and retained in a desired position and orientation. Further, embodiments in accordance with the present invention are well suited to use in numerous environments and present embodiments are not limited to any one single application.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. The invention utilizes a band, sleeve or strap to connect and secure the cables and or the splice case tail shaft, allowing stability when the splice case housing dome and dome locking ring are removed or reinstalled.

2. The band, sleeve or strap that allows the splice case to be secured is connected to a support arm, brace or other means to make a solid connection to a stationary support to provide a necessary means of stability. The support arm, brace or other means to make a solid, ridged will have a locking system on one or both ends to make the connection secure. The locking or binding connection of the band, sleeve or strap that incorporates the secure connection to the cables or Splice case housing is done with vise, a threaded stud and a nut or wing bolt or equivalent tensioner system that is connected a mounting system.

3. The band, sleeve or strap or equivalent creates a tension around the splice case tail shaft barrel or cables (A) when tightened together. This tightening process prevents (B) lateral and longitudinal movement of the splice case or cables.
